(19) United States
(12) Patent Application Publication
(10) Pub. No.: US 2004/0163109 A1
(43) Pub. Date: Aug. 19, 2004

(54) Method for controlling network digital broadcasting service and system therefore

(76) Inventors: Seung-Mi Kang, Yongin-city (KR); Young-Jip Kim, Suwon-city (KR); Ho-Hyun Park, Yongin-city (KR)

Correspondence Address: Robert E. Bushnell, 1522 K Street, N.W., Suite 300, Washington, DC, 20005, US

(21) Appl. No.: 10/773,298

(22) Filed: Feb. 9, 2004

(30) Foreign Application Priority Data
Feb. 13, 2003 (KR) 10-2003-9222

(51) Int. Cl. H04N 7/173; G06F 13/00; H04N 5/445; G06F 3/00; H04N 7/16; H04N 5/44

(52) U.S. Cl. 725/38; 725/135; 348/734; 725/120; 725/117; 725/147

(57) ABSTRACT

A method for servicing digital broadcasting, capable of defining a control message necessary for servicing digital broadcasting of a SD (Standard) level and a HD (High Definition) level through, a network of, for example, a x Digital Subscriber Line, by directly requesting, at a client, a digital broadcasting server for a session connection, and establishing a session by receiving a confirmation from the digital broadcasting server. Also, a channel change can be requested by directly requesting, at the client, the digital broadcasting server for a channel change, and changing a channel by receiving a confirmation from the digital broadcasting server. Other direct client-server requests and confirmations include a message for checking a status of the client and a session termination.

### CLAIM OF PRIORITY

This application makes reference to, and claims all benefits accruing under 35 U.S.C. §119 from an application for METHOD FOR CONTROLLING NETWORK DIGITAL BROADCASTING SERVICE earlier filed in the Korean Intellectual Property Office on Feb. 13, 2003 and thereby duly assigned Ser. No. 2003-9222.

### BACKGROUND OF INVENTION

1. Field of the Invention

The present invention relates to a method and system for controlling a network digital broadcasting service.

2. Description of Related Art

As digital broadcasting is made more consistent, a number of broadcasting service models are being suggested. Among them, in a digital broadcasting service model through a network, a defined standard for providing broadcasting service between a broadcasting server and a subscriber terminal is required.

In order for a subscriber apparatus (e.g. STB (Set Top Box)) to select one broadcasting channel from a multi-broadcasting server having a plurality of channels, a standard for defining a control message between a server and a subscriber apparatus, is required. For such a standard, a standard called “Part 6 of MPEG-2: Digital Storage Media-Command And Control” (referred to as DSM-CC hereinafter) defined under the “ISO/IEC 13818-6 International Standard” among standards generated by the International Organization for Standardization/International Electrotechnical Commission (ISO/IEC), has been prepared. MPEG refers to the Motion Picture Experts Group.

According to the DSM-CC standard, a session control and a channel change control are operated on different protocol stacks, respectively. Namely, a session control is based on TCP (Transmission Control Protocol)/UDP (User Datagram Protocol), and a channel change control is operated on the basis of AAL5 (ATM Adaptation Layer 5)/ATM (Asynchronous Transfer Mode).

Also, a DSM-CC standard defines messages presuming a client to network (particularly, SRM: Session Resource Manager) to server as a service object. FIG. 1 is a structural view for one known embodiment of a digital information transmission system to which such DSM-CC standard is applied.

Referring to FIG. 1, to realize, particularly, digital broadcasting service through a network (SRM) 12 in a digital information transmission system including a client 11, a server 13, and a network (SRM) 12, the client 11, for receiving a predetermined information or message using a digital storage media, uses the network (SRM) 12 to receive a message from the server 13.

Therefore, the network (SRM) 12 plays a role of connecting databetween the client 11 and the server 13, and when wanting to receive a service, the client 11 requests the network 12 for a message, then the network (SRM) 12 recognizes such request, ordering desired information to the server 13. The server 13 recognizes such order, transmitting desired information on the network (SRM) 12, and the network (SRM) 12 checks transmitted information and then transmits data information and a message to the client 11.

FIG. 2 is a representative general timing diagram for digital broadcasting suggested by a DSM-CC standard of the related art. Referring to FIG. 2, for a control message for DSM-CC suggested by a DSM-CC standard of the related art, “Confirm method” is used.

“Confirm method” used in a DSM-CC standard of the related art consists of a “Request” message, an “Indication” message, a “Response” message, and a “Confirm” message.

Namely, a “Request” message is generated when the client 11 or the server 13 begin a message transmission and is transferred to the network (SRM) 12. Also, the network (SRM) 12 delivers an “Indication” message which is information for a “Request” message to the server 13 or the client 11 with respect to such “Request” message. The sever 13 or the client 11 which receive an “Indication” message delivers a “Response” message to the network (SRM) 12 in response thereto. Then, the network (SRM) 12 responds with a final “Confirm” message, with respect to the client 11 or the server 13 which has initially delivered the “Request” message.

A method by a DSM-CC standard of the related art for delivering digital broadcasting data, includes the steps of: making a session; changing broadcasting; checking a status of a server; terminating, at a client, broadcasting service; and terminating, at a server, broadcasting service.

A method by a DSM-CC standard of the related art for delivering digital broadcasting data will be described in the following. First, a session is made between a client 11 and a server 13, for discriminating, at a network (SRM) 12, a subscriber apparatus (STB: Set Top Box) which is the client 11 in order to deliver such digital broadcasting data.

A process for making such session will be described with reference to FIG. 2, in which: the client 11 delivers a “ClientSessionSetupRequest” message T201 for establishing a session, to the network (SRM) 12, and the network (SRM) 12 which has received such message transmits a “ServerSessionSetupIndication” message T202 informing that there is a request for establishing a session from the client 11, to the sever 13.

Also, the server 13 transmits a “ServerSessionSetupResponse” message T203 to the network (SRM) 12, and the network (SRM) 12 which has received such message transmits a “ClientSessionSetupConfirm” message T204 to the client 11.

In the meantime, a process for releasing a session or a process for checking a status of a session is proceeded in the same manner.

Namely, a process for checking a status of the client 11 will be described in the following, in which: the client 11 transmits a “ClientStatusRequest” message T209 to the network (SRM) 12, and the network (SRM) 12 which has received such message transmits a “ClientStatuslndication” message T210 to the server 13. Then, the server 13 transmits a “ClientStatusResponse” message T211 to the network (SRM) 12, and the network (SRM) 12 which has received such message transmits a “ClientStatusConfirm” message T212 to the client 11.

Also, a process for checking the server 13 is performed in a following manner, in which: the server 13 transmits a “ServerStatusRequest” message T213 to the network (SRM) 12, and the network (SRM) 12 which has received such message transmits a “ServerStatuslndication” message T214 to the client 11, then, the client 11 transmits a “ServerStatusResponse” message T215 to the network (SRM) 12 and the network (SRM) 12 which has received such message transmits a “ServerStatusConfirm” message T216 to the server 13.

Also, a process for releasing, at the client 11, a session is performed in a following manner, in which: the client 11 transmits a “ClientReleaseRequest” message T217 to the network (SRM) 12 and the network (SRM) 12 which has received such message transmits a “ServerReleaseIndication” message T218 to the server 13, then the server 13 transmits a “ServerReleaseResponse” message T219 to the network (SRM) 12 and the network (SRM) 12 which has received such message transmits a “ServerReleaseConform” message T220 to the client 11.

In the meantime, a process for releasing, at the server 13, a session is performed in a following manner, in which: the server 13 transmits a “ServerReleaseRequest” message T221 to the network (SRM) 12 and the network (SRM) 12 which has received such message transmits a “ClientReleaseIndication” message T222 to the client 11, then the client 11 transmits a “ClientReleaseResponse” message T223 to the network (SRM) 12 and the network which has received such message transmits a “ClientReleaseConform” message T224 to the server 13.

In the meantime, as a channel changing process defined by a DSM-CC standard operates on AAL5/ATM, the client 11 directly transmits a “ProgramSelectRequest” message T205 to the server 13 without passing session resource manager (SRM) 12, and the server 13 which has received such message transmits a “ProgramSelectConfirm” message T206 and the client 11 transmits a “ProgramSelectIndication” message T207 to the server 13 without passing session resource manager (SRM) 12, then the server 13 transmits a “ProgramSelectResponse” message T208 to the client 11, so that the channel changing process is terminated.

A DSM-CC message used in the foregoing process consists of a message header that should be included in common for all the messages and a message payload for defining message data. Here, the message header includes a protocol discriminator and a message discriminator so that what kind of message has been transmitted, can be identified. Also, the message payload consists of peculiar data of each message. Among such peculiar data, detailed definitions are shown in Tables 1, 2, 3 with use of a “ClientSessionSetupRequest” message and a “ProgramSelectRequest” message for examples.

Table 1 shows a header format of a DSM-CC message. Referring to Table 1, a DSM-CC message includes: a protocol discriminator consisting of 1 byte; a DSM-CC type consisting of 1 byte; a message ID (identification) consisting of 2 bytes; a transaction ID consisting of 4 bytes; a Reserved of 1 byte; an adaptation length of 1 byte; and a message length of 2 bytes.

TABLE 1

| | A number |
|---|---|
| Contents | of bytes |
| DsmccMessageHeader ( ) { | |
| ProtocolDiscriminator | 1 |
| DsmccType | 1 |
| MessageID | 2 |
| TransactionID | 4 |
| Reserved | 1 |
| adaptationLength | 1 |
| messageLength | 2 |
| } | |

More specifically, the protocol discriminator is a field for indicating that a message is an MPEG-2 message.

Also, the DSM-CC type is a field for indicating an MPEG-2 DSM-CC type, and for its possible type, four types exist such as UN (User-Network) configuration, UN primitive, UU (User to User) configuration, and UU primitive.

The message ID is a field for determining a message type and the transaction ID is a field for session integrity or error processing. Also, the Reserved is a field for setting a value into “zero” for being reserved, and the adaptation length is a field for indicating a length of an adaptation part. The message length is a field for indicating a message length including the adaptation part.

Table 2 shows a format of a “ClientSessionSetUpRequest/Confirm” message among

TABLE 2

| | | A number |
|---|---|---|
| Contents | | of bytes |
| ClientSessionSetupRequest ( ) { | ClientSessionSetupConfirm ( ){ | |
| dsmccMessageHeader ( ) | dsmccMessageHeader ( ) | |
| SessionID | SessionID | 10/10 |
| Reserved | response | 2/2 |
| ClientID | ServerID | 20/20 |
| ServerID | Resources ( ) | 20/undefined |
| UserData | UserData | |
| } | } | |

In the Table 2, the session ID is a discriminator for identifying one session and is a value consisting of a device discriminator of 6 bytes and a session number of 4 bytes, and the client ID and the server ID are values for identifying a client and a server in the network, respectively.

The response has one code among codes such as “RspOK”, “RspNoSession”, “RspInvalidClient”, “RspInvalidServer”, “RspNoService”, “Reserved”. The client judges that a session is properly established only if a RspOK code is included in a response field and transmitted.

The Resources () is a field for including detailed information of resources required for service, and it is not required right now, for it presently shows resource information for MPEG only, but it would be used in case that IP service is added afterwards.

The UserData () is a part not defined in the standard and is depicted as “Out of Scope”.

Table 3 shows a format of a “ProgramSelectRequest/Confirm” message among DSM-CC messages.

TABLE 3

| | | A number |
|---|---|---|
| Contents | | of bytes |
| ProgramSelectRequest ( ) { | ProgramSelectConfirm ( ) { | |
| sessionId | sessionId | 10 |
| reserved | response | 2 |
| broadcastProgramId | broadcastProgramId | 4 |
| PrivateData ( ) | PrivateData ( ) | |
| } | } | |

In the Table 3, the broadcastProgramild is a discriminator of a video program. Zero means a case that there is no program and a range for valid values is from 0x00000001 to 0x7FFFFFFF.

The PrivateData () is a part not defined in the standard and is depicted as “Out of scope”.

But, messages defined by such DSM-CC standard are base standard taking all cases for a variety of data format into account. Therefore, there are several problems in applying this standard as it is, to broadcasting service.

First, messages taking general cases into account are defined, so that necessary messages are limited to a part depending on service characteristics.

Secondly, a network which is a terminal apparatus, namely SRM is provided between a client and a server, so that a procedure for communication is divided into two steps. Upon change of broadcasting through TCP/IP (Transmission Control Protocol/Internet Protocol), changing time should be reduced as much as possible. In that regard, characteristics of dividing a procedure into two steps is a disturbing factor.

### SUMMARY OF THE INVENTION

To solve the above-indicated problems, it is an object of the present invention to provide a method for servicing digital broadcasting, capable of defining a control message necessary for servicing digital broadcasting of a SD (Standard) level and a HD (High Definition) level through, for example, an xDSL (x Digital Subscriber Line).

Also, it is an object of the present invention to provide a method for controlling network digital broadcasting service, capable of realizing a session control and a channel change control on the same protocol stack by selecting only necessary control messages for servicing digital broadcasting, adding necessary part for service, making specialized protocol, and capable of reducing channel changing time by directly giving and taking messages without passing through a session resource manager (SRM).

The foregoing and other objects and advantages are realized by providing a method for controlling network digital broadcasting service, including the steps of: directly requesting, at a client, a digital broadcasting server for a session connection, and establishing a session by receiving a confirmation from the digital broadcasting server; directly requesting, at the client, the digital broadcasting server for a program change, and changing a program by receiving a confirmation from the digital broadcasting server; receiving, at the client, a message for checking a status of the client from the digital broadcasting server, and directly delivering a confirmation message from the client to the digital broadcasting server; and directly requesting, at the client, the digital broadcasting server for a session termination and terminating a session by receiving a confirmation from the digital broadcasting server.

The foregoing and other objects and advantages are additionally realized by providing a method for controlling network digital broadcasting service, including the steps of: directly requesting, at a client, a digital broadcasting server for a session connection, and establishing a session by receiving a confirmation from the digital broadcasting server; directly requesting, at the client, the digital broadcasting server for a program change, and changing a program by receiving a confirmation from the digital broadcasting server; receiving, at the client, a message for checking a status of the client from the digital broadcasting server, and directly delivering a confirmation message from the client to the digital broadcasting server; and directly requesting, at the digital broadcasting server, the client for a session termination and terminating a session by receiving a confirmation from the client.

Foregoing and other objects and advantages are also realized by providing a method for controlling network digital broadcasting service, including the steps of: receiving, at a digital broadcasting server, a session setup request directly from a client, and establishing a session by directly delivering a session setup confirmation message to the client; receiving, at the digital broadcasting server, a program select request from the client, and changing a channel by directly delivering a program select confirmation message to the client; directly transmitting, at the digital broadcasting server, a server status request for checking a status of the client, to the client, and receiving a server status confirmation message from the client; and receiving, at the digital broadcasting server, a client release request for session termination from the client, and terminating a session by directly delivering a client release confirmation message to the client.

Foregoing and other objects and advantages are further realized by providing a method for controlling network digital broadcasting service, including the steps of: receiving, at a digital broadcasting server, a session setup request directly from a client, and establishing a session by directly delivering a session setup confirmation message to the client; receiving, at the digital broadcasting server, a program select request from the client, and changing a channel by directly delivering a program select confirmation message to the client; directly transmitting, at the digital broadcasting server, a server status request for checking a status of the client, to the client, and receiving a server status confirmation message from the client; and receiving, at the client, a server release request for session termination from the digital broadcasting server, and terminating a session by directly delivering a server release confirmation message to the digital broadcasting server.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a structural view for a digital information transmission system to which a DSM-CC standard of the prior art is applied;

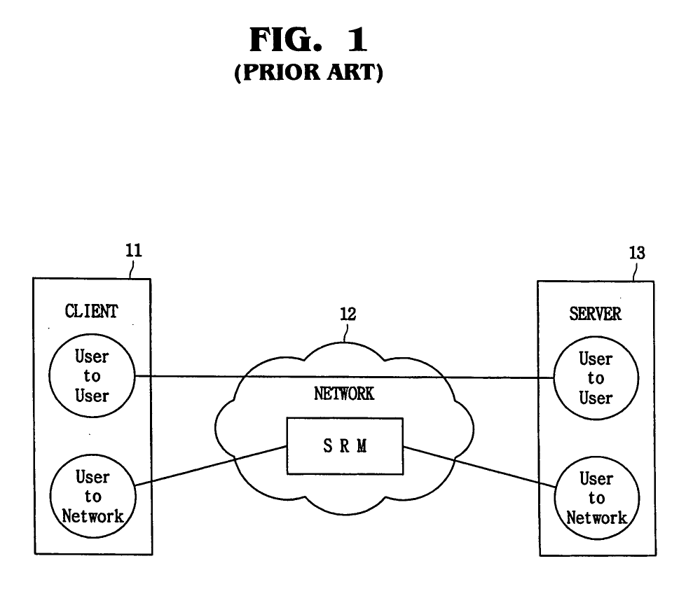

FIG. 2 is a representative general timing diagram for digital broadcasting suggested by a DSM-CC standard of the related art; and

FIG. 3 is a timing diagram for network digital broadcasting according to a preferred embodiment of the present invention.

### DETAILED DESCRIPTION OF EXEMPLARY EMBODIMENTS

A preferred embodiment of the present invention will now be described with reference to the accompanying drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

In case of a VDSL (Very high-bit rate Digital Subscriber Line) presently under progress, channel data of all the channels could not be provided to the general household via a VDSL line like the case of FTA (Free to Air: ground wave) due to data transmission and reception speed restrictions (presently, maximum 52 Mbps for downward, 19.39 Mbps for broadcasting of a HD level). Therefore, a request for desired channel should be made through a network, and a subscriber apparatus should receive and show the relevant channel. By providing a message standard for realizing such broadcast changing procedure, it is possible to directly control broadcasting on a TCP/IP network and to watch a high quality channel.

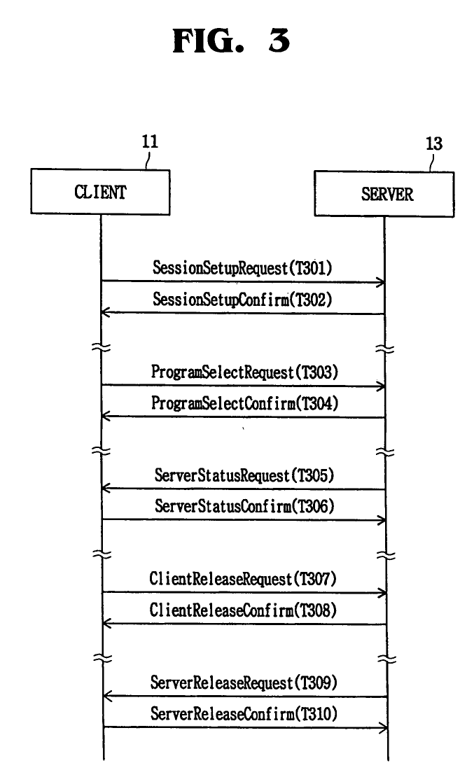

FIG. 3 is a timing diagram for a network digital broadcasting according to a preferred embodiment of the present invention. Referring to FIG. 3, according to the present invention, unlike the related art, an operation for the digital broadcasting is directly performed through “Request” and “Confirm” between a client 1 1 and a server 13 without going through “Indication” and “Response” steps.

Like the method by DSM-CC of the related art for delivering digital broadcasting data, a process for delivering digital broadcasting data according to the present invention, includes the steps of: establishing a session; changing a channel (or program); checking a status of a client; terminating, at a client, broadcasting service; and terminating, at a server, broadcasting service.

A method for delivering digital broadcasting data according to the present invention will be described with reference to an embodiment shown in FIG. 3. First, a process for establishing a session between a client 11 and a server 13 is performed without passing through a session resource manager (SRM). Namely, the client 11 directly transmits a “SessionSetupRequest” message T301 to the server 13 and the server 13 directly transmits a “SessionSetupConfirm” message T302 to the client 11 in response thereto, so that a session is established.

Also, a channel changing process is performed on TCP/IP like the case of a session control, so that complexity of the message control of the related art could be reduced. Therefore, upon channel change, the client 11 transmits a “ProgramSelectRequest” message T303 to the server 13 and the server 13 transmits a “ProgramSelectConfirm” message T304 to the client 11.

In the meantime, the server 13 transmits a “ServerStatusRequest” message T305 in order to regularly check whether the client 11 (subscriber apparatus (set top box)) operates constantly, and the client 11 responds to the server 13 by sending a “ServerStatusConfirm” message T306 to the server 13.

Also, upon termination of the digital broadcasting service, a simple configuration of “Request-Confirm” is used. Namely, when requesting, at the client 11, a broadcasting termination, the client 11 transmits a “ClientReleaseRequest” message T307 to the server 13, and the server 13 transmits a “ClientReleaseConfirm” message T308 to the client, so that a session is terminated. On the contrary, when requesting, at the server 13, a broadcasting termination, the server 13 transmits a “ServerReleaseRequest” message T309 to the client 11 and the client 11 transmits a “ServerReleaseConfirm” message T310, so that a session is terminated.

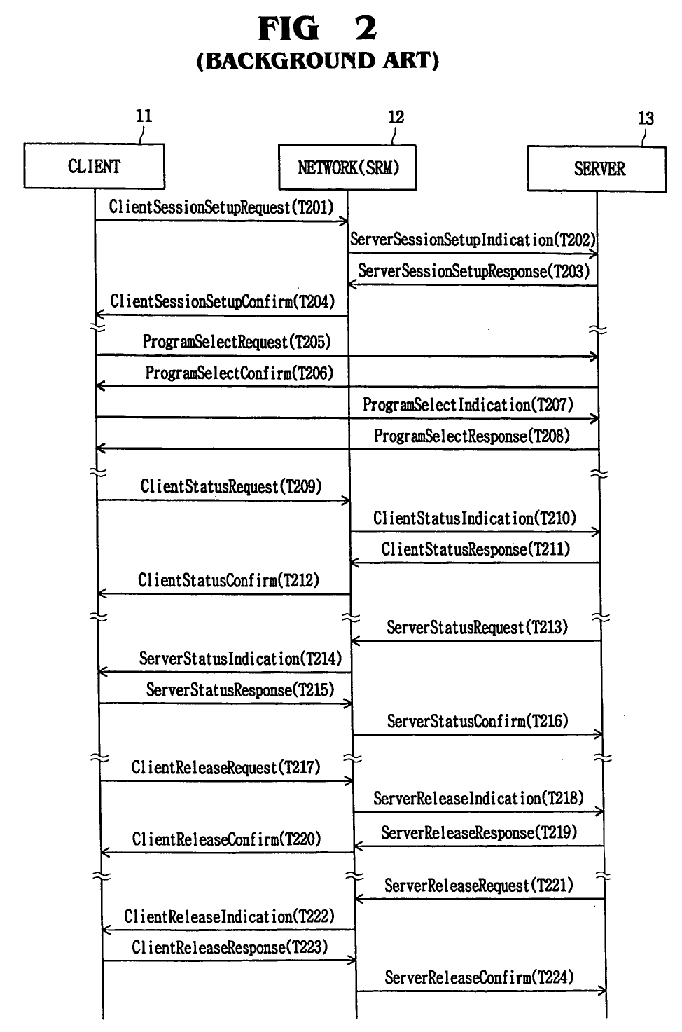

In the meantime, the present invention has newly constructed a payload of a DSM-CC standard message in order to service digital broadcasting . The process for performing service operation between a client 11 and a server 13 according to the present invention is different from the standard suggested by FIG. 2 in that service is directly delivered without passing through the session resource manager (SRM). Accordingly, a channel change message format and a status check message format have been changed appropriate for the service. Also, remarkably modified characteristics is that a session control and a channel change control are performed on the same protocol stack, so that all the messages include a message header. With such construction, a control becomes possible in a more simple process than the standard of the related art suggested in FIG. 2.

For such message construction, refer to Table 4 through Table 7, below.

Table 4 shows a format of a “SessionSetUpRequest/Confirm” message among digital broadcasting service messages through, for example, an xDSL according to the present invention.

TABLE 4

| | | A number |
|---|---|---|
| Contents | | of bytes |
| SessionSetupRequest ( ) { | SessionSetupConfirm ( ) { | |
| dsmccMessageHeader ( ) | dsmccMessageHeader ( ) | |
| SessionID | SessionID | 10/10 |
| Reserved | response | 2/2 |
| ClientID | ServerID | 20/20 |
| ServerID | } | 20/ |
| } | | |

As shown in FIG. 4, a “ClientSessionSetUpRequest/Confirm” message defined by the present invention uses a message header of a DSM-CC standard for its message header. Also, a message delivering process that has passed through four steps of “Request”—“Indication”—“Response”—“Confirm” in the standard of the related art, is reduced and instead, a message delivering process is realized merely by two steps of “Request”—“Confirm”. In the meantime, UserData (), Resources () that have been used for the standard of the related art, are not used. For a client ID and a server ID, it is regulated that an address of OSI (Open Systems Interconnection) E.164 NSAP (Network Service Access Point), but a serial number given from an authentication organization is used.

Table 5 shows a format of a “ProgramSelectRequest/Confirm” message among digital broadcasting service messages through, for example, an xDSL according to the present invention.

TABLE 5

| | | A number |
|---|---|---|
| Contents | | of bytes |
| ProgramSelectRequest ( ) { | ProgramSelectConfirm ( ) { | |
| dsmccMessageHeader ( ) | dsmccMessageHeader ( ) | |
| SessionID | SessionID | 10/10 |
| STB status | response | 2/2 |
| broadcast ProgramId | broadcast ProgramId | 20/20 |
| Client ID | Client ID | 20/20 |
| } | } | |

As broadcasting has been performed on AAL5/ATM in a DSM-CC standard of the related art, a message header has not been required. But, as a channel change message of the present invention is operated on TCP/IP like a case of a session connection message, a channel change message is constructed in the same format as the session connection message. Therefore, a message header and a client ID field are additionally provided.

Also, a “STBStatus” field is added to a payload described in a DSM-CC standard of the related art so that a “Request” message is transmitted, whereby the general broadcasting and VOD (Video On Demand) could be discriminated. Also, a “Request” message is transmitted with a channel number to change put into its “broadcastprogramld” field.

Table 6 shows a format of a “ReleaseRequest/Confirm” message among digital broadcasting service messages through, for example, an xDSL according to the present invention.

TABLE 6

| | | A number |
|---|---|---|
| Contents | | of bytes |
| ReleaseRequest ( ) { | ReleaseConfirm ( ) { | |
| dsmccMessageHeader ( ) | dsmccMessageHeader ( ) | |
| SessionID | SessionID | 10/10 |
| Reason | response | 2/2 |
| ClientID | ClientID ( ) | |
| } | } | |

The Client 11 could request a “ReleaseRequest” message in order to terminate a session, and the server 13 may also request a “ReleaseRequest” message in order to terminate a session by checking a status of the client 11. The response message has one code among “RspOK”, “RspNosession”, “RspInvalidClient”, “RspInvalidServer”, “RspNoService”, “Reserved”, and the client 11 releases a session if a “RspOK” code is received.

Table 7 shows a format of a “ServerStatusRequest/Confirm” message among digital broadcasting service messages through, for example, an xDSL according to the present invention.

TABLE 7

| | | A number |
|---|---|---|
| Contents | | of bytes |
| ServerStatusRequest ( ) { | SeverStatusConfirm ( ) { | |
| dsmccMessageHeader ( ) | dsmccMessageHeader ( ) | |
| Reason | Response | 2/2 |
| StatusType | StatusType | 2/2 |
| resourceNumber | resourceNumber | 2/2 |
| Reserved | resourceStatus | 2/2 |
| ClientID | ClientID | 20/20 |
| } | } | |

In case that a connection between the client 11 and the server 13 is abnormally terminated, the server 13 continues to broadcast, for a session is not normally terminated. In order to prevent such resource waste, the server 13 should regularly check a status of the client 11. At the moment, a message transmitted to the client from the server 13 is a “ServerStatusRequest” message.

Generally, the server 13 checks a status of the client 11 every thirty minutes, and if the client 13 does not transmit a “Confirm” message, the server 13 repeatedly transmits a “Request” message two times by short periods. If a “Confirm” message is not received even in this time, the server 13 terminates a session by transmitting a “Release request” message to the client 11. Such check period is possibly changed on the program.

A DSM-CC standard of the related art defines “reason”,“statusType”,“statusCount” fields, and the present invention adds “resourceNumber”,“resourceStatus”,“clientId” fields to that. For a “reason” field, one code among “RsnOk”, “RsnNormal”, “RsnError”, “Reserved” is possibly used. A “resourceNumber” among the added fields is a number of a resource (e.g. MPEG) whose status is wanted to be known. Also, a “resourceStatus” field is a field for informing a resource's status, showing a status that whether MPEG resource is being used.

The method of the present invention as described above, could be realized in form of a program and stored at recording media such as CD-ROM (Compact Disk-Read Only Memory), RAM (Random Access Memory), a floppy disk, a hard disk, an optical magnetic disk, etc., in a form that could be read by a computer.

As is apparent from the foregoing, the present invention accepts standard, extensionality, universality as a base standard with respect to DSM-CC of the related art, and is capable of performing swift message control.

Also, the present invention unifies a basic protocol stack, so that realization of the present invention is easy.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for controlling network digital broadcasting service, comprising steps of:
directly requesting, at a client, a digital broadcasting server for a session connection, and establishing a session by receiving a confirmation message for the session connection from the digital broadcasting server; and
directly requesting, at the client, the digital broadcasting server for a channel change, and changing a channel by receiving a confirmation message for the channel change from the digital broadcasting server.

2. The method according to claim 1, further comprising:
receiving, at the client, a message for checking a status of the client from the digital broadcasting server, and directly delivering a confirmation message for checking the status of the client to the digital broadcasting server.

3. The method according to claim 1, further comprising:
directly requesting, at the client, the digital broadcasting server for a session termination and terminating a session by receiving a confirmation message for the session termination from the digital broadcasting server.

4. The method according to claim 1, further comprising:
directly requesting, at the digital broadcasting server, the client for a session termination and terminating a session by receiving a confirmation message for the session termination from the client.

5. The method according to claim 1, further comprising the step of directly receiving, at the client, a session termination request from the digital broadcasting server, and terminating a session if the client cannot transmit a response to the session termination request from the digital broadcasting server.

6. The method according to claim 1, wherein a protocol between the client and the digital broadcasting server is a TCP/IP (Transmission Control Protocol/Internet Protocol).

7. The method according to claim 1, wherein a message for requesting the session connection is a SessionSetupRequest message including: a DSM-CC (Digital Storage Media-Command and Control) message header field, a Session ID (Identification) field, a Reserved field, a Client ID field, and a Server ID field, and the SessionSetupRequest message is transmitted from the client to the digital broadcasting server.

8. The method according to claim 1, wherein a message for requesting the channel change is a ProgramSelectRequest message including: a DSM-CC (Digital Storage Media-Command and Control) message header field, a Session ID (Identification) field, a STB (Set Top Box) status field, a broadcast ProgramId field, and a Client ID field, and the ProgramSelectRequest message is transmitted from the client to the digital broadcasting server.

9. The method according to claim 2, wherein the message for checking the status of the client is a ServerStatusRequest message including: a DSM-CC (Digital Storage Media-Command and Control) message header field, a Reason field, a statusType field, a resourceNumber field for showing a number of a resource whose status is wanted to be known, a Reserved field, and a client ID field, and the ServerStatusRequest message is transmitted from the digital broadcasting server to the client.

10. The method according to claim 3, wherein a message for requesting a session termination is a ClientReleaseRequest message including: a DSM-CC (Digital Storage Media-Command and Control) message header field, a session ID field, a Reason field, and a ClientID field, and the ClientReleaseRequest message is transmitted from the client to the digital broadcasting server.

11. The method according to claim 4, wherein a message for requesting a session termination is a ServerReleaseRequest message including: a DSM-CC (Digital Storage Media-Command and Control) message header field, a session ID field, a Reason field, and a ClientID field, and the ServerReleaseRequest message is transmitted from the digital broadcasting server to the client.

12. The method according to claim 1, wherein the confirmation message for confirming the session connection is a SessionSetupConfirm message including: a DSM-CC (Digital Storage Media-Command and Control) message header field, a Session ID (Identification) field, a response field, and a Server ID field, and the SessionSetupConfirm message is transmitted from the digital broadcasting server to the client.

13. The method according to claim 1, wherein the confirmation message for confirming the channel change is a ProgramSelectConfirm message including: a DSM-CC (Digital Storage Media-Command and Control) message header field, a Session ID (Identification) field, a response field, a broadcast ProgramId field, and a Client ID field, and the ProgramSelectConfirm message is transmitted from the digital broadcasting server to the client.

14. The method according to claim 2, wherein the confirmation message for confirming the status of the client is a ServerStatusConfirm message including: a DSM-CC (Digital Storage Media-Command and Control) message header field, a Response field, a statusType field, a resourceNumber field for showing a number of a resource whose status is wanted to be known, a resourseStatus field, and a client ID field, and the ServerStatusConfirm message is transmitted from the client to the digital broadcasting server for confirming the status of the client.

15. The method according to claim 3, wherein the confirmation message for confirming a session termination is a ClientReleaseConfirm message including: a DSM-CC (Digital Storage Media-Command and Control) message header field, a session ID field, a response field, and a ClientID field, and the ClientReleaseConfirm message is transmitted from the digital broadcasting server to the client.

16. The method according to claim 4, wherein the confirmation message for confirming a session termination is a ServerReleaseConfirm message including: a DSM-CC (Digital Storage Media-Command and Control) message header field, a session ID field, a response field, and a ClientID field, and the ServerReleaseConfirm message is transmitted from the client to the digital broadcasting server.

17. A system controlling a network digital broadcasting service comprises:
a client and a digital broadcasting server, the client directly requesting the digital broadcasting server for a session connection, and establishing a session by receiving a confirmation message for the session connection from the digital broadcasting server; and
the client directly requesting a program change from the digital broadcasting server and receiving a confirmation message from the digital broadcasting server, when the digital broadcasting server confirms the channel change.

18. The system according to claim 17, further comprising:
the client periodically receiving a message from the digital broadcasting server for checking a status of the client, and directly delivering a client status confirmation message, indicative of the status of the client, to the digital broadcasting server.

19. The system according to claim 17, further comprising:
the client directly requesting the digital broadcasting server for a session termination and terminating a session by receiving a confirmation message for the session termination from the digital broadcasting server.

20. The system according to claim 17, further comprising:
the digital broadcasting server directly requesting the client for a session termination and terminating a session by receiving a confirmation message for the session termination from the client.
